(19) United States
(12) Patent Application Publication
(10) Pub. No.: US 2016/0031182 A1
(43) Pub. Date: Feb. 4, 2016

(54) COMPOSITE FLANGE WITH THREE-DIMENSIONAL WEAVE ARCHITECTURE

(71) Applicant: UNITED TECHNOLOGIES CORPORATION, Hartford, CT (US)

(72) Inventors: CHRISTOPHER M. QUINN, Middletown, CT (US); SREENIVASA R. VOLETI, Farmington, CT (US)

(73) Assignee: UNITED TECHNOLOGIES CORPORATION, Hartford, CT (US)

(21) Appl. No.: 14/884,538

(22) Filed: Oct. 15, 2015

Related U.S. Application Data
(63) Continuation of application No. PCT/US2014/042967, filed on Jun. 18, 2014.
(60) Provisional application No. 61/868,022, filed on Aug. 20, 2013.

(51) Int. Cl. B32B 5/12; B29C 70/68; B32B 5/26; B32B 3/26; B32B 5/02

(52) U.S. Cl. CPC B32B 5/12; B32B 3/26; B32B 5/024; B32B 5/26; B29C 70/688; B32B 2262/106; B32B 2605/18; B32B 2260/021; B32B 2260/046; B29K 2063/00

(57) ABSTRACT

According to various embodiments, a carbon fiber structure is presented. The carbon fiber structure may address loads presented to an engine component in various directions. For instance, non-planar surfaces of a composite comprising a structure disclosed herein may achieve enhanced stiffness and/or strength. Thus, delamination of elements comprising a structure disclosed herein may be reduced. A three dimensional weave of carbon fiber elements through-thickness may provide enhanced strength to the composite material.

### CROSS-REFERENCE TO RELATED APPLICATIONS

This application is a continuation of, claims priority to and the benefit of, PCT/US2014/042967 filed on Jun. 18, 2014 and entitled “COMPOSITE FLANGE WITH THREE-DIMENSIONAL WEAVE ARCHITECTURE,” which claims priority from U.S. Provisional Application No. 61/868,022 filed on Aug. 20, 2013 and entitled “COMPOSITE FLANGE WITH THREE-DIMENSIONAL WEAVE ARCHITECTURE.” Both of the aforementioned applications are incorporated herein by reference in their entirety.

### FIELD OF INVENTION

The present disclosure relates generally to composite materials. More particularly, the present disclosure relates to a strengthening and/or stiffening a composite material.

### BACKGROUND OF THE INVENTION

Composite materials often are desirable as they address various limitations in the parent material. For instance, ceramics have a reputation for being brittle as compare with other materials, (e.g. polymers or metals.) Thus, ceramic composites may be formed to increase the plasticity of the material and address the brittle nature of the base ceramic material. Composite material systems are systems that comprise of more than one material. Typically, a composite material comprises of a matrix (which is either a polymer, ceramic or metal) filled with inclusions, which take the form of either long fibers, short fibers, or particles. Fibers are typically made of carbon, Kevlar or glass, Silicon carbide etc.

Machinery and various apparatuses may be made from composites. Carbon-fiber-reinforced polymer, carbon-fiber-reinforced plastic or carbon-fiber reinforced thermoplastic (“CFRP,” “CRP,” “CFRTP,” respectively), may be strong and relatively light weight fiber-reinforced polymers which comprise carbon fibers. In the composites industry, a tow may refer to an untwisted bundle of substantially continuous filaments/fibers. Composite materials may be used in engine components. These components may have three dimensional shapes and have loads applied at various angles along the varied three dimensional shaped surfaces.

### SUMMARY OF THE INVENTION

According to various embodiments, an improved composite materials structure is presented. The composite materials may be a carbon fiber structure or other fiber/matrix combination. The improved carbon fiber structure may, among other advantages, withstand loads presented to an engine component in various directions. For instance, non-planar surfaces of a composite comprising a structure disclosed herein may achieve enhanced stiffness and/or strength. Delamination of elements comprising a structure disclosed herein may be reduced.

According to various embodiments, a composite structure configured to address delamination may include a first plurality of tows of carbon fiber oriented substantially parallel to each other, wherein a center axis of the first plurality of tows are parallel to a X axis, a second plurality of tows of carbon fiber oriented substantially parallel to each other, wherein the center axis of the second plurality of tows are oriented in a direction parallel to a Y axis, a third plurality of tows of carbon fiber oriented substantially parallel to each other, wherein the center axis of a portion of each tow in the third plurality of tows of carbon fiber are at least partially oriented in a direction parallel to an angle less than 90 degrees from a Z axis. The first plurality of tows, the second plurality of tows, and the third plurality of tows, may be interweaved together to form a three dimensional ply.

According to various embodiments, a method for addressing delamination in a composite structure includes placing layers of three dimensional stacked plies in a target area, such as a non-flat surface of a mold. The three dimensional stacked plies may include interweaved fibers that are at least partially oriented in a direction parallel to a X plane, are at least partially oriented in a direction parallel to a Y plane, and that are at least partially oriented in a direction parallel to a Z plane. The method may include the contents of the mold, e.g. the three dimensional stacked plies, undergoing a curing process (e.g. forming a laminate). The three dimensional stacked plies may be formed from multiple layers of plies stacked in the Z direction, wherein the fibers at least partially oriented in a direction parallel to the Z plane pass through more than one layer.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1A illustrates a schematic axial cross-section view showing an example of a gas turbine engine according to various embodiments of the disclosure;

FIG. 1B illustrates a close up view of the cross-sectional view of the fan containment case according to various embodiments of the disclosure;

FIG. 2 illustrates a close up view of the cross-sectional view of a curved structure that forms forward flange coupled to a portion of an inlet according to various embodiments of the disclosure;

FIGS. 3-7 illustrate various three dimensional interweaved architectures according to various embodiments of the disclosure; and

FIG. 8 illustrates a method according to various embodiments of the disclosure.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the inventions, it should be understood that other embodiments may be realized and that logical, chemical, and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

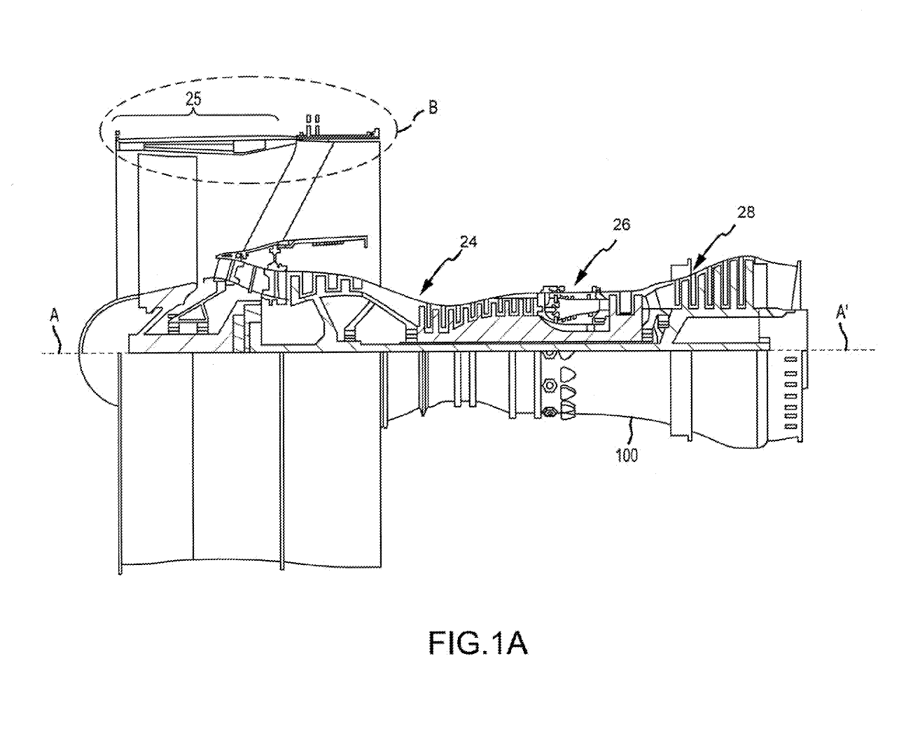

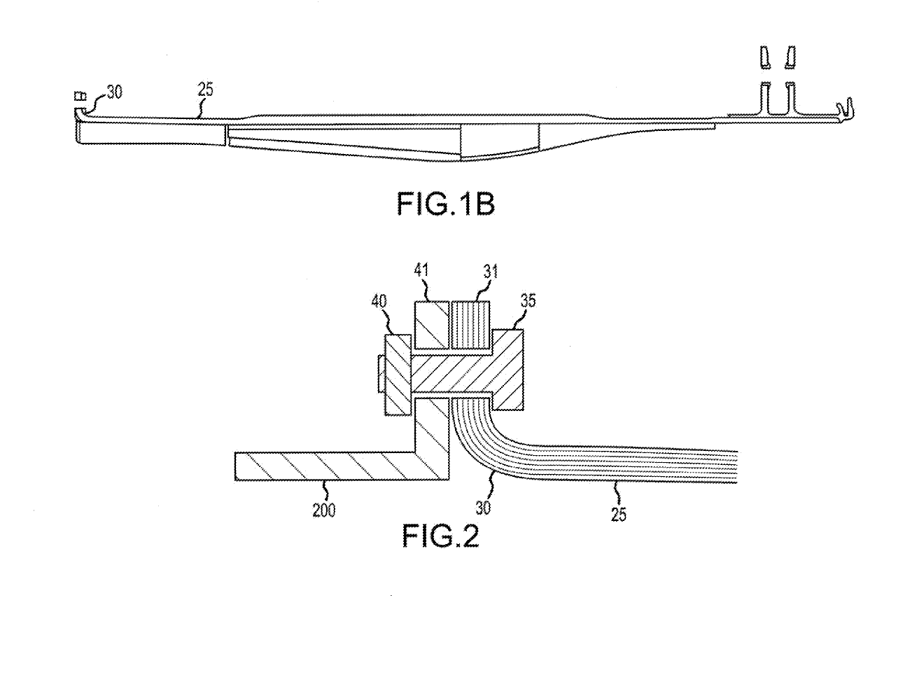

In various embodiments and with reference to FIG. 1, a gas turbine engine 100 is provided. Gas turbine engine 100 may be a two-spool turbofan that generally incorporates a fan section, comprising a fan containment case 25 (“FCC”), a compressor section 24, a combustor section 26 and a turbine section 28. Alternative engine designs may include, for example, a gearbox between the fan section and rest of the engine, an augmenter section among other systems or features. In operation, fan section 25 moves air, most of which moves along a bypass flow-path while some enters a compressor section 24, which moves air along a core flow-path for compression and communication into the combustor section 26 followed by expansion through a turbine section 28. Although gas turbine engine 100 is depicted as a turbofan gas turbine engine herein, it should be understood that the concepts described herein are not limited to use with turbofans as the teachings may be applied to other types of turbine engines including those with three-spool architectures and other aircraft components.

According to various embodiments and with reference to FIGS. 1A through 2, engine components may be made from a carbon fiber/epoxy composite material, though in further embodiments, engine components may be made from any suitable material. For example, engine components may be made from a composite material comprising a fiber material and a filler material (e.g., epoxy and/or resin). For instance, the fan containment case 25 of gas turbine engine 100 may be made from a carbon fiber/epoxy composite material. At the forward end, (i.e., end “A” of the axis defined by the line A-A′) FCC 25 has an upturned flange 31, which interfaces with a mating flange 41 on the inlet cowl 200 of a nacelle. Flange 41 may be coupled to composite flange 31 via a coupler such as via a nut 40 and bolt 35. In the illustrated embodiment, the composite flange 31 on FCC 25 is most susceptible to delaminations from inter-laminar tension stress under axial and bending loads based on the shapes and curved surfaces 30 that form the structure of the FCC 25 forward flange 31. In laminated materials, repeated cyclic stresses, impact, applied, forces and/or the like so on can cause layers to separate, forming a mica-like structure of separate layers, with significant loss of mechanical toughness. Often, this loss of strength of the composite material is not ascertainable upon visual inspection.

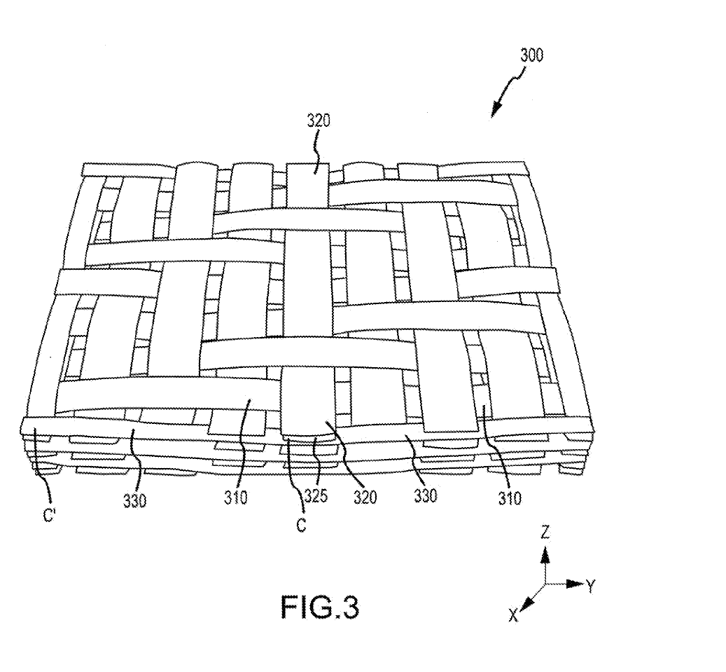

Inter-laminar tension in composites is a mode of stress where the laminate experiences through-thickness stresses that can cause delamination. Typically, composite laminates are laid out in sheets of plies (two dimensional ply architecture). The strength of the plies are high in the plane of the plies (the X and Y planes), and lower, normal to the plane, (Z direction) i.e. through the thickness (see FIG. 3 for exemplary X, Y and Z axes). Inter-laminar strength values are typically very low, and these are the limiting condition of a composite component that is otherwise strong in other directions. In response to the inter-laminar strength being improved, an engine element, such as FCC 25 forward flange 31, with an increased lifespan, that is less susceptible to damage, and made lighter weight may be made. Disclosed herein is a composite material having increased inter-laminar strength.

According to various embodiments and with reference to FIG. 3, a composite structure 300 with a three-dimensional (3D) weave is illustrated, where tows of carbon 310, 320, 325, 330, glass and/or other fibers or materials are woven into the flange plies through the thickness direction (Z direction). Stated another way, tows of carbon 310, 320, 325, 330 vary along the z axis as they travel along the x axis and/or y axis. This is in contrast to a typical two dimensional weave ply (not shown). Typically, in a 2 dimensional weave ply, a first set of a plurality of tows are oriented 90 degrees from and generally perpendicular to the alignment of a second set of the orientation of a plurality of tows. These two sets of plurality of tows may be weaved together such that tows oriented in the first direction tow may be oriented above or under a 90 degree offset tow to create a two dimensional ply of tows. In a two dimensional structure, the 90 degree offset tows that are interweaved do not enter into plies that are above or below their ply.

Graphite-epoxy parts may be produced by layering sheets of carbon fiber (e.g. plies), onto/into a mold in a desire shape, or through the use of vacuum bags, as are known generally in the art. The alignment and weave of the cloth fibers is chosen to optimize the strength and stiffness properties of the resulting material. For instance, a first layer of ply cross-weaved material may be placed with one set of its cross-weaved fibers aligned with an axis. A second layer of ply cross weaved material may be placed on top of the first layer with one set of its cross waved fibers offset by 45 degrees from the axis. A third layer may be placed on top of the second layer with one set of its cross waved fibers offset by 90 degrees from the axis and so on. The plies may be pre-impregnated with epoxy and/or the mold is then filled with epoxy. The contents of the mold may undergo a curing process.

According to various embodiments, in a three dimensional weave of tows, tows may pass through a stack of ply levels from a location such as an outer surface of the stack of plies and/or an interior location within the stack of plies, to a second interior location within the stack of plies and/or second outer surface of the stack of plies where the tows extend through at least one of the entire thickness of the stack of plies and less than the entire thickness of a stack of plies. A stack of plies may include more than one level of ply. Stated another way, the through-thickness reinforcement may extend through the full thickness of the laminate (as shown in FIG. 7). One or more layers of ply within a portion of a composite material may have through-thickness reinforcement that extends into the layer above and/or which creates a through-thickness reinforcement between the layers, such as all layers, in the laminate. According to various embodiments, the through-thickness tows (e.g. tows that are oriented in substantially the Z direction) do not pass all the way through the thickness of an entire stack of plies, rather several ‘layers’ of though-thickness tows are used to gradually go through layer-by-layer. This structure may create strong and/or stiff composite material. Thus, less layers of ply may be used to create a structure of equivalent strength. Thus, the overall thickness and weight of the composite may be reduced.

According to various embodiments and with reference to exemplary FIGS. 3-7, a weave of tows forming a ply may comprise parallel rows of tows oriented in a direction substantially parallel to the X plane. A weave may be created where parallel rows of tows oriented in a direction substantially parallel to the Y plane and weaved into the tows oriented in the X plane. The weave may further comprise additional rows of tows, fibers or other materials are at least partially oriented in a direction substantially parallel to the Z plane and/or offset from the Z plane at an angle less than 90 degrees and weaved into the tows oriented in the X and Y plane. In general, the tows which are at least partially oriented in a direction substantially parallel to the Z plane and/or offset from the Z plane at an angle less than 90 degrees will pass through more than one layer of ply and/or more than one plane of X and/or Y direction oriented tows. As described herein the X and/or Y direction oriented tows may be highly structured such that a plurality of tow fibers are aligned substantially parallel to each other in various planes.

As depicted herein, tows may be weaved such that multiple layers of offset oriented tows may be above or under a tow or plane of oriented tows. These tows are interweaved and configured to be oriented within the weave such that a portion of their orientation is in the Z direction. Tows may cross into layers/levels within a ply stack that one or are more than one layer above or below the instant tow position.

For instance, and with reference to FIG. 3, a first tow, such as a tow of carbon fiber 330 may be oriented substantially in a direction parallel to the Y plane. Stated another way, the center axis of a tow of carbon fiber's length may be oriented parallel to the Y plane. A second tow, such as a tow of carbon fiber 325, may be oriented substantially in a direction parallel to the X plane, approximately 90 degrees offset from the direction of tow 330. Second tow 330 may be oriented directly above tow 330 at a location, such as location C. A third tow, such as a tow of carbon fiber 320 may be oriented substantially in direction parallel to the X plane, approximately 90 degrees offset from the direction of tow 330. Third tow 320 may be oriented above tow 330 and tow 325 relative to a location, such as location C. Thus, at location C, the stack of tows including tow 330 may comprise 2 two tows of carbon fiber directly above tow 330 (in the Z direction) and 4 tows of carbon fiber directly below tow 330 (in the Z direction). At location C′ tow 330 may be the top of a stack of tows with 6 tows of carbon directly below tow 330 (in the Z direction). Tow 330 at location C′ is relatively above tow 330 at location C. Stated another way, each tow of carbon fiber, such as tows 310, 320 325, 330 may be weaved such that they pass under and over multiple levels and/or layers of tows. This resulting three dimensional weave structure may comprise enhanced strength in the Z direction for the resulting composite material. A first three dimensional weave of plies may be layered on a second two dimensional ply, a stack of two dimensional plies and/or a second three dimensional stack of plies. Multiple three dimensional stacks of plies, each stack having different structural orientations, for instance those exemplary structural orientations depicted in FIGS. 3-7 may be stacked on top of each other prior to a curing process. Moreover, three dimensional stacks of plies may be located, such as within a mold, in curved location. In this way, the curved location may receive the benefit of the enhanced strength in the thickness direction (Z direction). These stacks of plies may be located by a ply laying machine or by hand.

Tows of carbon, glass or other fibers in the thickness direction provide improved stiffness and strength by virtue of the tows that support the laminate in the thickness direction. Tows of carbon, glass or other fibers weaved through other plies, wherein at least one tow is oriented in the thickness direction may address delamination concerns. This delamination concern may be particularly evident in a composite material formed in a curved or non-planar structure, such as surface 30 of FCC 25. A non-planar surface may be one that is not flat. For instance, forces applied to the structure may be applied at angles on these curved surfaces where the composite material's strength is not optimized.

Tows oriented at least partially in the Z direction may pass through one or more level of plies and/or extend from the top to the bottom level of plies in a stack of plies. Tows may be oriented in the Z plane and/or an angle offset from the Z plane, typically less than 90 degrees.

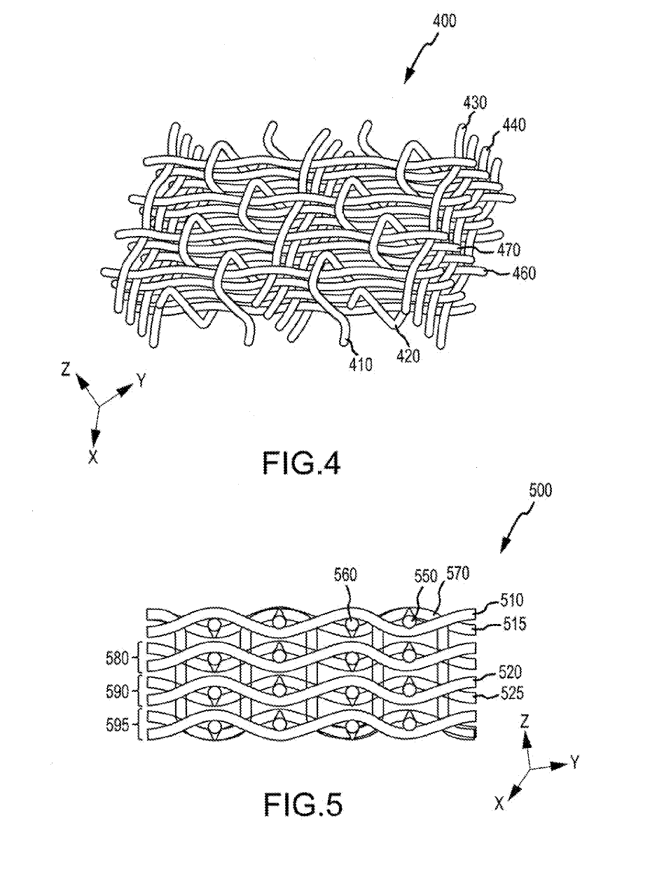

According to various embodiments and with reference to FIG. 4, a composite structure 400 is depicted. Tows 430 and 440 may be substantially aligned in a direction substantially parallel to the X plane. Tows 460 and 470 may be substantially aligned in a direction substantially parallel to the Y plane. Stated another way, tows 430 and 440 may be oriented 90 degrees offset from tows 460 and 470. Tows 410 and 420 may pass through the planes comprising tows 430 and 440 and/or tows 460 and 470. Tows 410 and 420 may travel in a direction substantially parallel to the Z plane. Tows 410, 420, 430, 440, 460, and 470 are weaved together. This structure having tows oriented in directions substantially parallel to the X, Y and Z planes and/or an angle offset less than 90 degrees from one or more of the X, Y, and Z planes may combat delamination of the composite. This structure having tows oriented in directions substantially parallel to the X, Y and Z planes and/or an angle offset less than 90 degrees from one or more of the X, Y, and Z planes increase the through thickness strength of the composite material.

According to various embodiments and with reference to FIG. 5, a composite structure 500 is depicted. Tow 510 and tow 515 may be oriented in planes substantially parallel to the Y plane. Tow 550 may be oriented in a plane substantially parallel to the X plane. Tow 560 may be oriented in a plane substantially parallel to the X plane. Tows 510 and 515 may be weaved below and above tow 550 respectively. Tows 510 and 515 may be weaved above and below tow 560 respectively. Tows 550 and 560 may be oriented in the X direction and be substantially parallel in the Y plane. Tow 570 may cross above tow 550 in a direction parallel to the Y plane. Tow 570 may cross below tow 560 in a direction parallel to the Y plane. Tow 570 may pass through layers 580, 590 and 595.

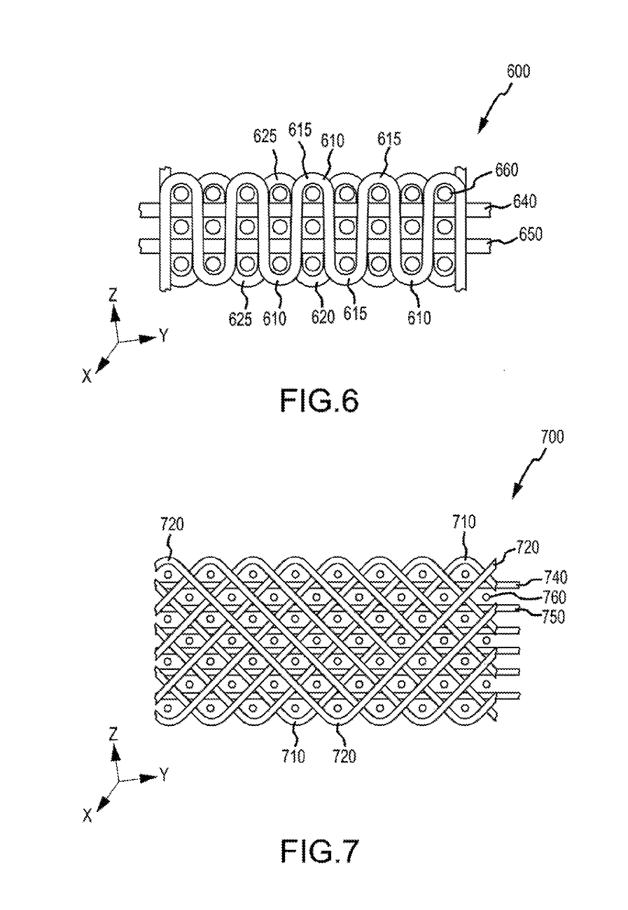

According to various embodiments and with reference to FIG. 6, a composite structure 600 is depicted. Tow 640 and tow 650 may be oriented in a plane substantially parallel to the Y plane. Tow 660 may be oriented in a plane substantially parallel to the X plane. Tow 610 may serpentine and primarily travel in directions parallel to the Z plane with linking portions 615 substantially in a direction parallel to the Y plane. Tow 610 may be weaved through tows oriented in substantially in the X direction. Tow 620 may serpentine and primarily travel in directions parallel to the Z plane with linking portions 625 substantially in a direction parallel to the Y plane. Tow 620 may be weaved through tows oriented in substantially in the X direction.

According to various embodiments and with reference to FIG. 7, a composite structure 700 is depicted. Tow 710 and tow 720 may be oriented in a plane substantially parallel to the Y plane. Tow 710 and tow 720 may form a plurality of Vs along their path of travel. They may be oriented in a direction substantially 45 degrees offset from the Z plane. Tow 740 and tow 750 may be oriented in a plane substantially parallel to the Y plane. Tow 760 may be oriented in a direction substantially parallel to the X plane. Tows 710 and 720 may be weaved through tows 740, 750 and 760.

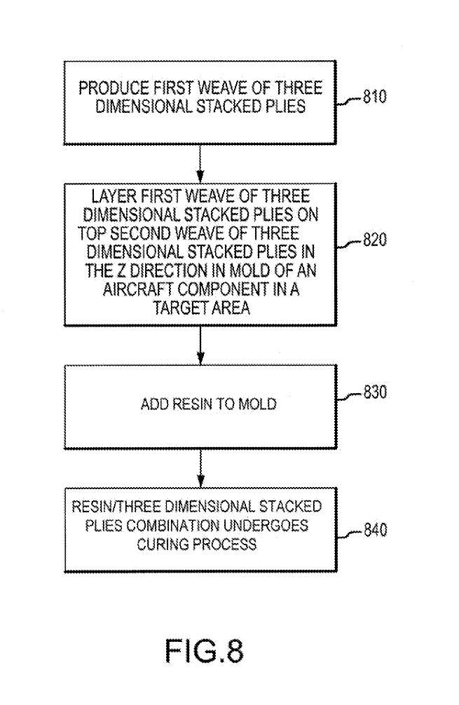

According to various embodiments and with reference to FIG. 8, a process for exploiting the strength of the composite material is disclosed. A three dimensional weave of stacked plies may be formed (Step 810). This weave of plies may be layered into a mold. The layers may be stacked in the Z direction. The mold may be a negative of an aircraft component and/or a portion of an aircraft component. The three dimensional weave of stacked plies may be concentrated in a target area (Step 820). The through-thickness strength of the resultant laminate may be increased in proportion to the amount of and/or degree of inter-wovenness of the three dimensional weave of stacked plies. The target area may be a non-flat surface of the mold/aircraft component and/or a portion of an aircraft component, such as an engine component and/or nacelle component. Stated another way, according to various embodiments, the composite may be formed having both three dimensional plies and two dimensional plies stacked in layers, and stacked on each other. The three dimensional stacked plies may be concentrated along surfaces that may receive forces in varied directions. According to various embodiments, the composite may be formed having three dimensional plies stacked in layers. The mold may be closed. The mold may be filled with a hardening agent, such as resin. (Step 830). The three dimensional ply layered in the mold and resin combination undergoes a curing process (Step 840). This method may address delamination of the composite material.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. Different cross-hatching may be used throughout the figures to denote different parts but not necessarily to denote the same or different materials. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus

1. A composite structure configured to improve delamination resistance and/or composite structure strength comprising:
a first plurality of tows of fiber oriented substantially parallel to each other, wherein a center axis of the first plurality of tows are substantially parallel to a X axis;
a second plurality of tows of fiber oriented substantially parallel to each other, wherein the center axis of the second plurality of tows are oriented in a direction substantially parallel to a Y axis;
a third plurality of tows of fiber oriented substantially parallel to each other, wherein the center axis of a portion of each tow in the third plurality of tows of fiber are at least partially oriented in a direction parallel to an angle less than 90 degrees from a Z axis,
wherein the first plurality of tows, the second plurality of tows, and the third plurality of tows, are interweaved together to form a three dimensional ply.

2. The composite structure of claim 1, wherein an aircraft component comprises a structure formed from the three dimensional ply.

3. The composite structure of claim 2, wherein the aircraft component is an engine component.

4. The composite structure of claim 2, wherein the aircraft component comprises a non-planar surface portion.

5. The composite structure of claim 1, wherein the three dimensional ply further comprises multiple layers of interweaved tows, wherein the tows are substantially oriented in a direction parallel to the X and Y axes.

6. The composite structure of claim 5, wherein tows are at least partially oriented in a direction parallel to the angle less than 90 degrees from the Z axis pass through more than one layer of the multiple layers of interweaved tows in the direction substantially parallel to the Z axis.

7. The composite structure of claim 5, wherein a plurality of three dimensional plies are layered on top of each other.

8. The composite structure of claim 1, wherein the three dimensional ply is layered in at least one of a mold and a vacuum bag.

9. The composite structure of claim 8, wherein resin is introduced to the mold the three dimensional ply layered in the mold and resin combination undergoes a curing process.

10. The composite structure of claim 8, wherein location of the three dimensional ply layered in the mold is determined based on a surface contour of the mold.

11. A composite structure having improved delamination resistance in a composite structure and/or improved composite structure strength comprising:
a first layer of interweaved carbon fiber composite ply;
a second layer of interweaved carbon fiber composite ply, wherein the first layer of interweaved carbon fiber composite ply is positioned substantially above the second layer of interweaved carbon fiber composite ply; and
a plurality of carbon fibers at least partially oriented in a direction parallel with a Z axis; wherein the plurality of carbon fibers pass through the first layer and the second layer of interweaved carbon fiber composite ply to form a three dimensional stack of plies.

12. The composite structure of claim 11, wherein an aircraft component comprises a structure formed from the three dimensional stack of plies.

13. The composite structure of claim 12, wherein the aircraft component is an engine component.

14. The composite structure of claim 12, wherein the aircraft component comprises a non-planar surface portion.

15. The composite structure of claim 12, wherein the three dimensional stack of plies is layered in a mold.

16. The composite structure of claim 15, wherein location of the three dimensional stack of plies layered in the mold is determined based on a surface contour of the mold.

17. A method for at least one of addressing delamination in a composite structure and improving composite structure strength comprising;
placing layers of three dimensional stacked plies in a target area of a mold, wherein the three dimensional stacked plies comprise interweaved fibers that are at least partially oriented in a direction parallel to a X plane, are at least partially oriented in a direction parallel to a Y plane, and that are at least partially oriented in a direction parallel to a Z plane; and
introducing resin to the three dimensional stacked plies as part of a curing process.

18. The method of claim 17, wherein the mold is of a portion of an aircraft engine component.

19. The method of claim 17, wherein the target area comprises a non-flat surface of the mold.

20. The method of claim 17, wherein the three dimensional stacked plies comprise multiple layers of plies stacked in the Z direction, wherein the fibers at least partially oriented in a direction parallel to the Z plane pass through more than one layer.
